(19) United States
(12) Patent Application Publication
(10) Pub. No.: US 2023/0086661 A1
(43) Pub. Date: Mar. 23, 2023

(54) 5MBS AMF SERVICE DISCOVERY FOR MB-SMF

(71) Applicant: Telefonaktiebolaget LM Ericsson (publ), Stockholm (SE)

(72) Inventors: Hans Bertil Rönneke, Kungsbacka (SE); Jie Ling, Shanghai (CN); Juying Gan, Shanghai (CN); Joakim Åkesson, Landvetter (SE)

(21) Appl. No.: 17/922,665

(22) PCT Filed: May 5, 2021
(86) PCT No.: PCT/EP2021/061782

§ 371 Date: Nov. 1, 2022

(30) Foreign Application Priority Data
May 5, 2020 (WO) PCT/CN2020/088574

(51) Int. Cl. H04W 4/06; H04L 65/1073; H04L 65/1093

(52) U.S. Cl. CPC H04W 4/06; H04L 65/1073; H04L 65/1093

(57) ABSTRACT

Solutions are proposed herein that provide several alternatives for how an AMF can perform discovery of a proper MB-SMF or MB-SMF instance in the network.

### TECHNICAL FIELD

The present disclosure relates to Multicast/Broadcast (MB) service in a cellular communications system.

### BACKGROUND

The Third Generation Partnership Project (3GPP) developed the Multicast/Broadcast Multimedia Subsystem (MBMS) see 3GPP Technical Specification (TS) 23.246 v16.1.0) for 3^{rd} Generation (3G) networks for video multicast/broadcasting and streaming services and later introduced the evolved MBMS (eMBMS) for the Evolved Packet System (EPS). In Release 13 and Release 14, the MBMS system has been updated to support new services such as Public Safety, Cellular Internet of Things (CloT), and Vehicle-to-Anything (V2X).

The scope of a new Release 17 study in the 3GPP SA2 working group is to study both multicast requirements and use cases for CloT, Public Safety, V2X etc., and dedicated broadcasting requirements and use cases. The study targets the 5^{th} Generation (5G) Release 17 and the New Radio (NR) radio access. The study results so far have been documented in the TR 23.757 V0.3.0.

Multicast / Broadcast (MB) services (MBS) are so far not supported on 5G NR. With the enhanced characteristics of 5G NR e.g. short delays, bandwidth, etc., it is believed that Mission Critical Services (e.g., Mission Critical Push To Talk (MCPTT), Mission Critical Data (MCData), and Mission Critical Video (MCVideo)), as well as VTX services, will show an enhanced and much better performance on 5G NR.

For 5G MBS Multicast support, the 5G System (5GS) must support UEs joining multicast groups. “Joining” is sometimes referred to as “Multicast Service Activation”. 5G Multicast Broadcast Sessions (referred to as “5G MB Sessions” or sometimes as “MB Sessions”, “MBS Sessions”, or MBS Bearers) must also be possible to be started, i.e. transmission of data or media to the group of UEs is started. Compare with MBMS TS 23.246 V16.1.0 clause 8.2 “MBMS Multicast Service Activation” and clause 8.3 “MBMS Session Start Procedure”.

Tentative proposals on Join and Session Start are outlined in TR 23.757 V0.3.0, see e.g. figure 6.2.2.1-1, figure 6.3.2-1, figure 6.4.2.2-1, figure 6.6.2.1-1, etc.

### Figure 1

FIG. 1 illustrates an example from Figure 6.2.2.1-1 of TR 23.757 V0.3.0. The following description is from TR 23.757 V0.3.0, where editorial comments and notes made herein are denoted by bracketed text.

NOTE 1: Procedure (A) can happen prior to, in parallel with, or after Steps 0, 4, 5 and 6. MBS service related configuration (e.g., TMGI allocation) occurs prior UE starting MBS service setup towards 5GS.

Editor’s note: How the TMGI is provided to the UE is FFS (e.g. from the AF, via PCF etc.).
0. UE interacted with the Application Server (AS), and the MBS Session will be started some time later.
1. The Application Server starts MBS Session.
2. The MB-SMF requests the MB-UPF to allocate IP address and port for receiving downlink traffic. The MB-SMF also requests MB-UPF to allocate the multicast address and C-TEID if the multicast address and C-TEID allocation is done by the MB-UPF.
3. The MB-SMF responds to the Application Server with the IP address and port which the AS can send packets to.
4. The UE notifies the NG-RAN that the UE is interested in a specific MBS service represented by TMGI [Temporary Mobile Group Identity (TMGI). The MBMS bearer is uniquely identified by one TMGI and the service (e.g. MCPTT, MCData, MCVideo etc.) carried by this bearer may be identified by a Service ID or similar preferably included in the TMGI.].
Editor’s note: It is FFS whether UE expresses interest in a specific MBS service unconditionally (i.e., even if radio resources for this specific MBS service have already been allocated or even when the UE is in an area where the MBS service is not available). Whether RRC signalling can be used by UE to express interest in a specific MBS service depends on work in RAN WGs.
5. No radio resource has been allocated for the MBS service, and the NG-RAN notifies the M-AMF [Multicast AMF or Multicast/Broadcast AMF, which may be a normal AMF that supports MBS] of its interest. If radio resource has been allocated, step 5 to step 11 are skipped.
6. The MBS Session for the MBS service is not started yet in the M-AMF, and the M-AMF stores the info that NG-RAN has interest in a specific MBS service and notifies the SMF of its interest in an MBS Service. If the MBS session has been started in the M-AMF, step 6 to step 9 are skipped.
Editor’s note: How the M-AMF discovers the MB-SMF is FFS. Editor’s note: A check whether the UE is authorized to access the MBS service is FFS.
7. If the MBS Session is already started, the MB-SMF immediately initiates the MBS Session towards the M-AMF, otherwise, the MB-SMF wait for the MBS Session start from MBSF/AF and then initiates MBS Session towards the M-AMF.
8-9. MB-SMF initiates the MBS Session Start Request towards the M-AMF including the multicast address and C-TEID.
10-11. The M-AMF sends the MBS Session Request also to the NG-RAN.

### SUMMARY

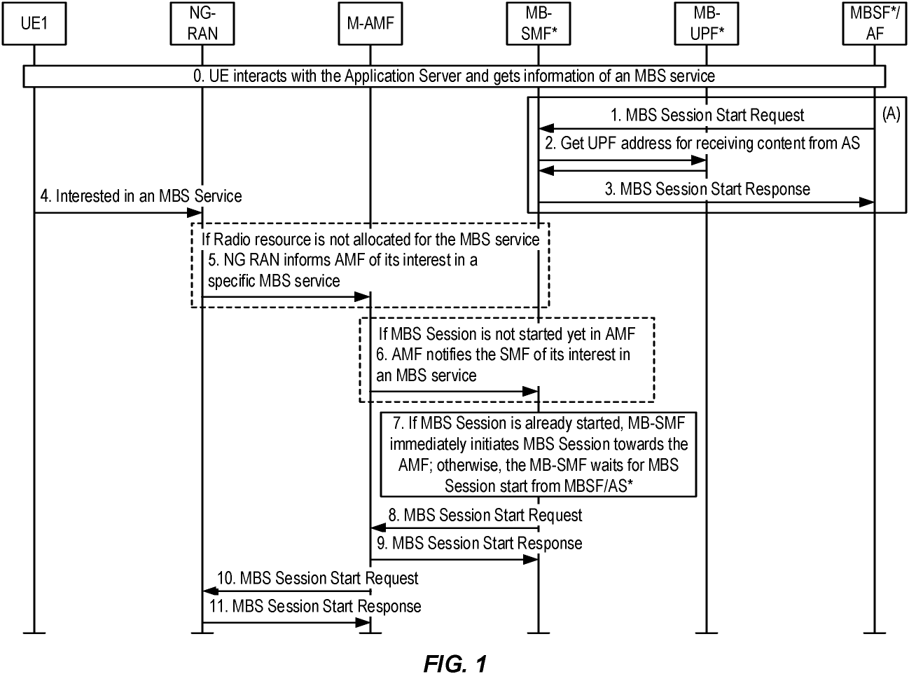

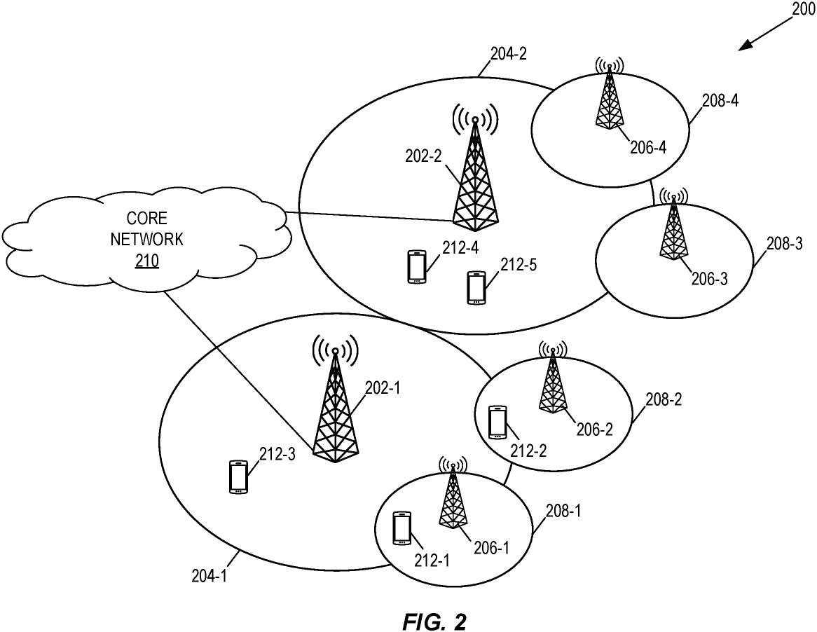

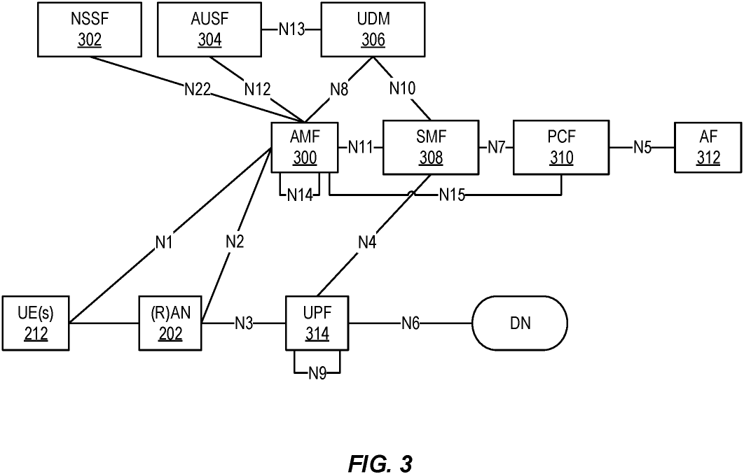

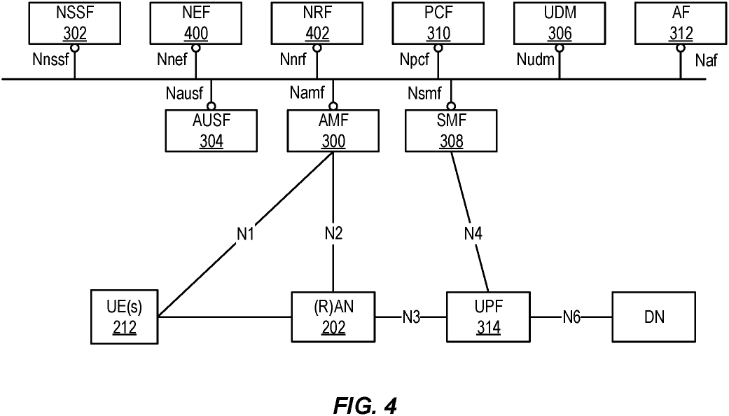

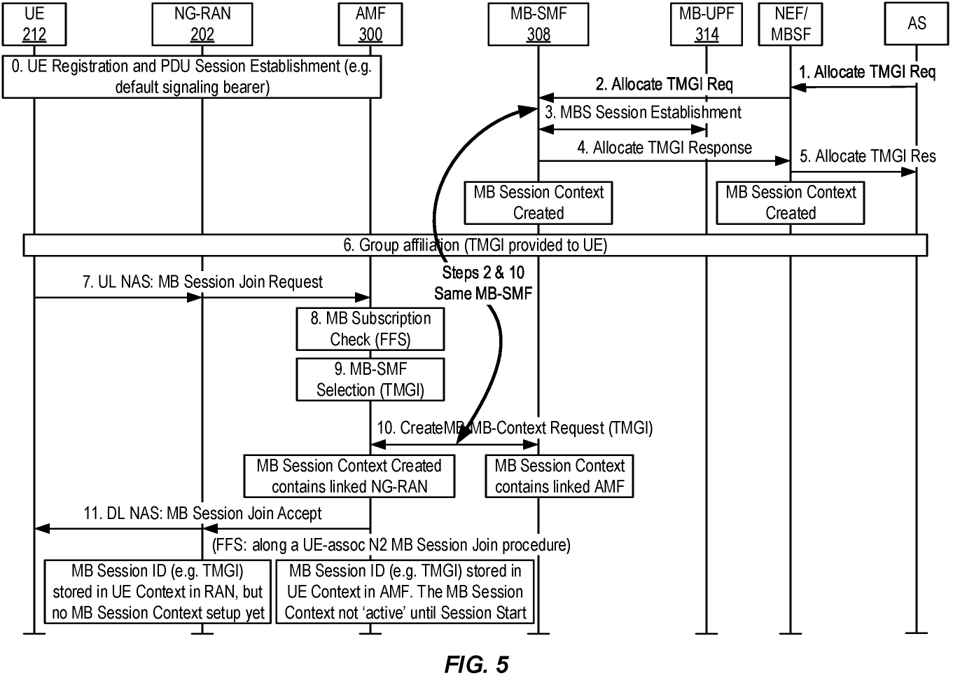

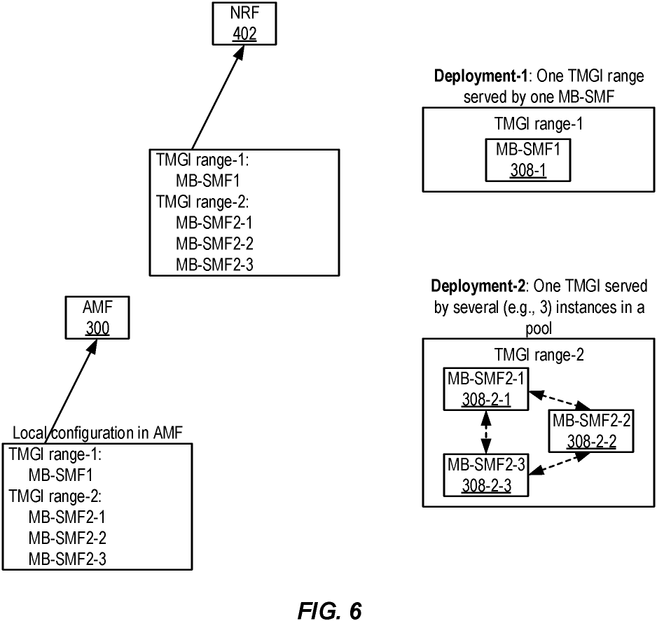

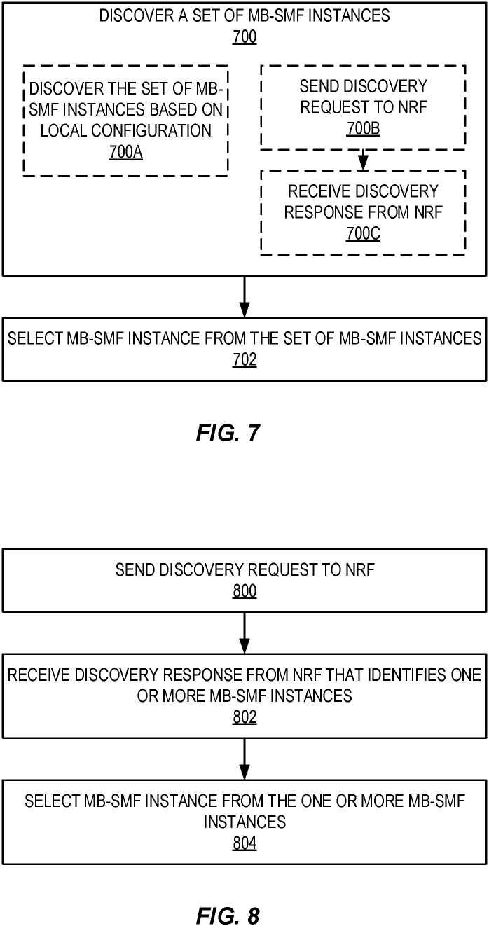

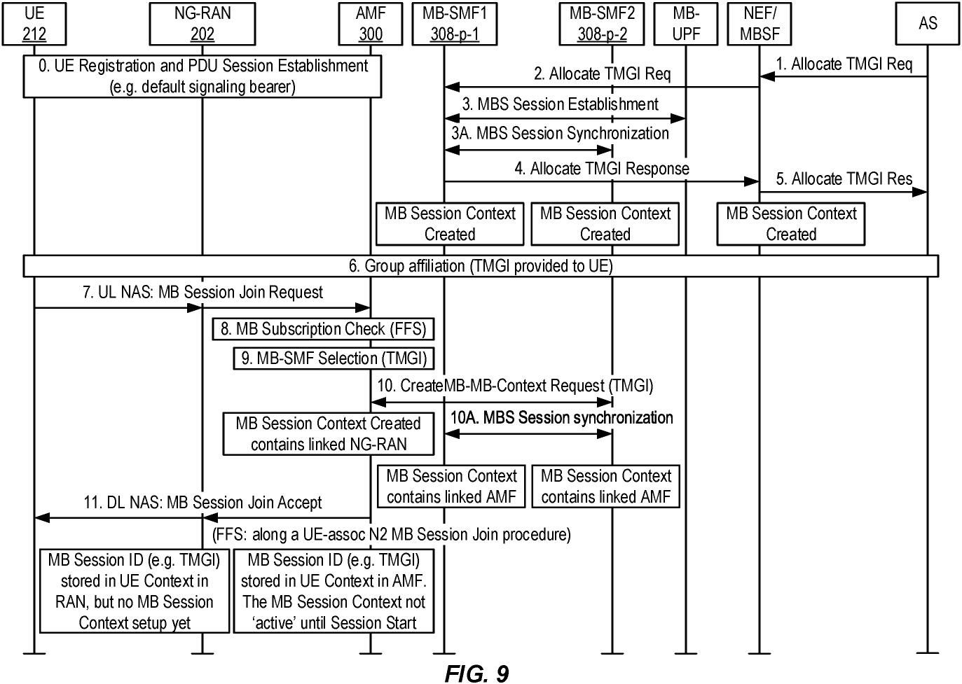

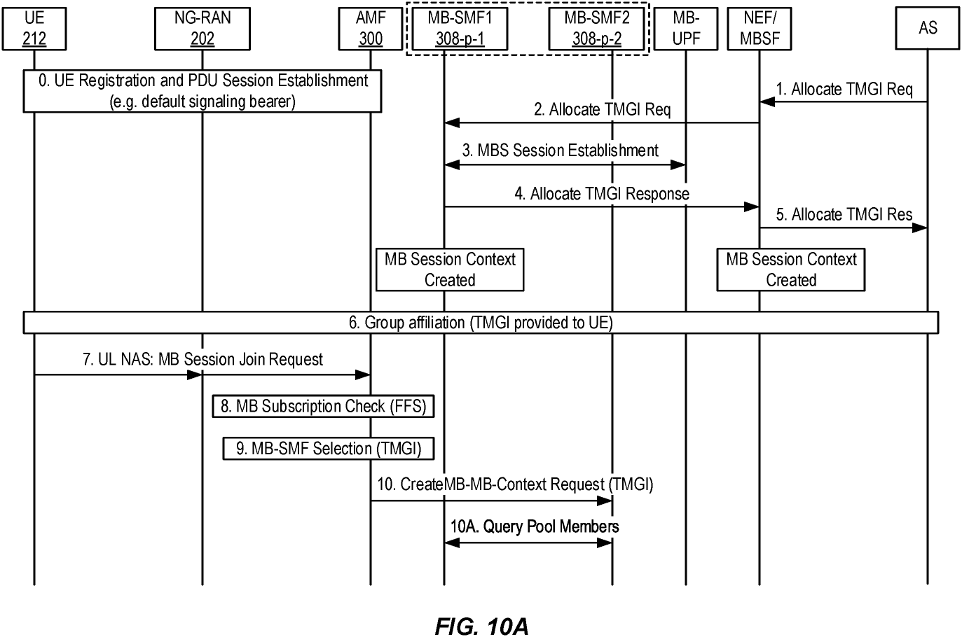

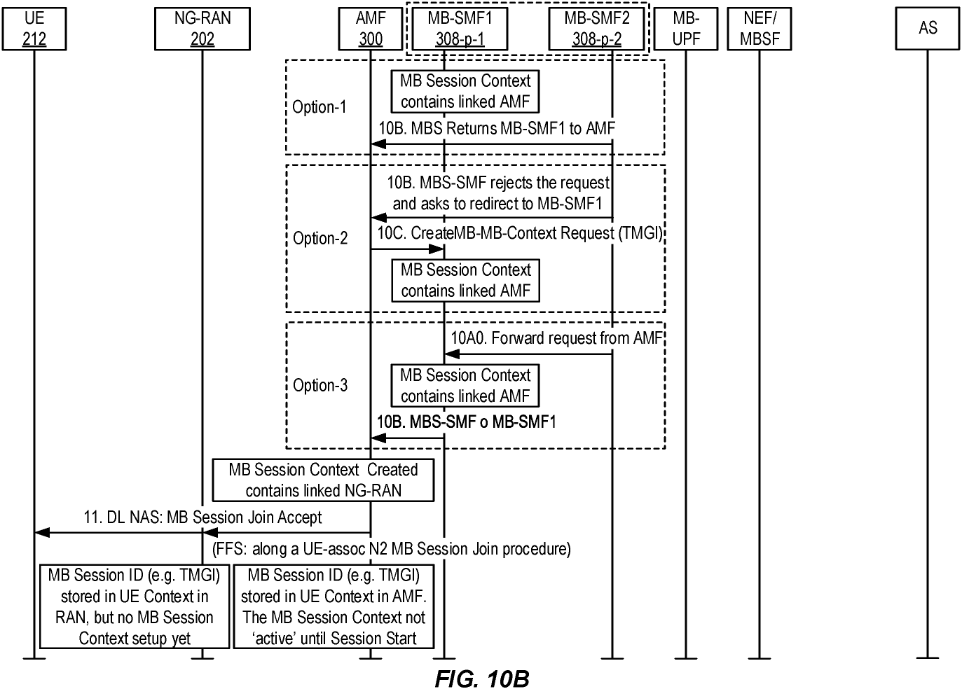

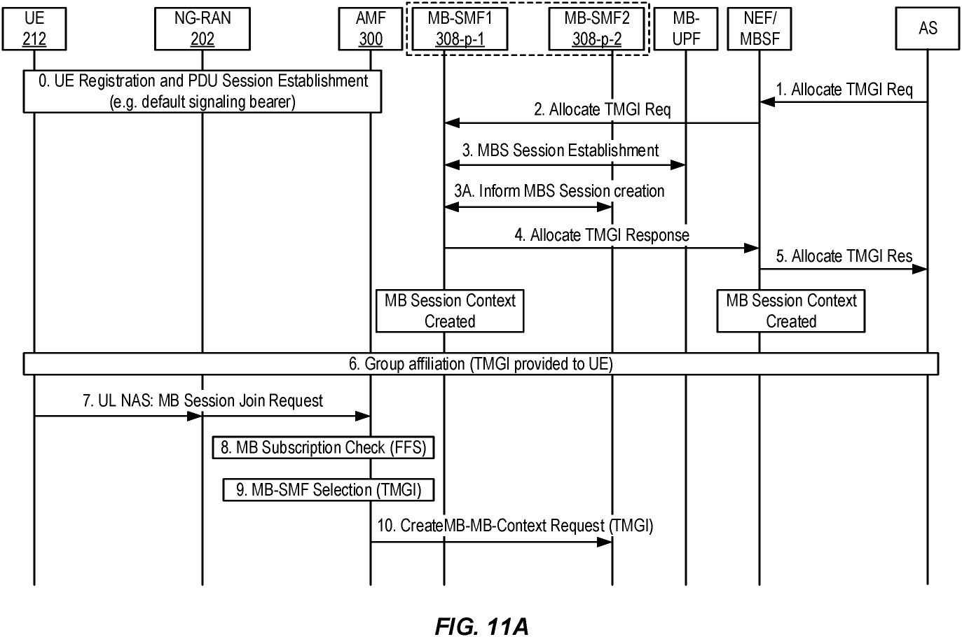

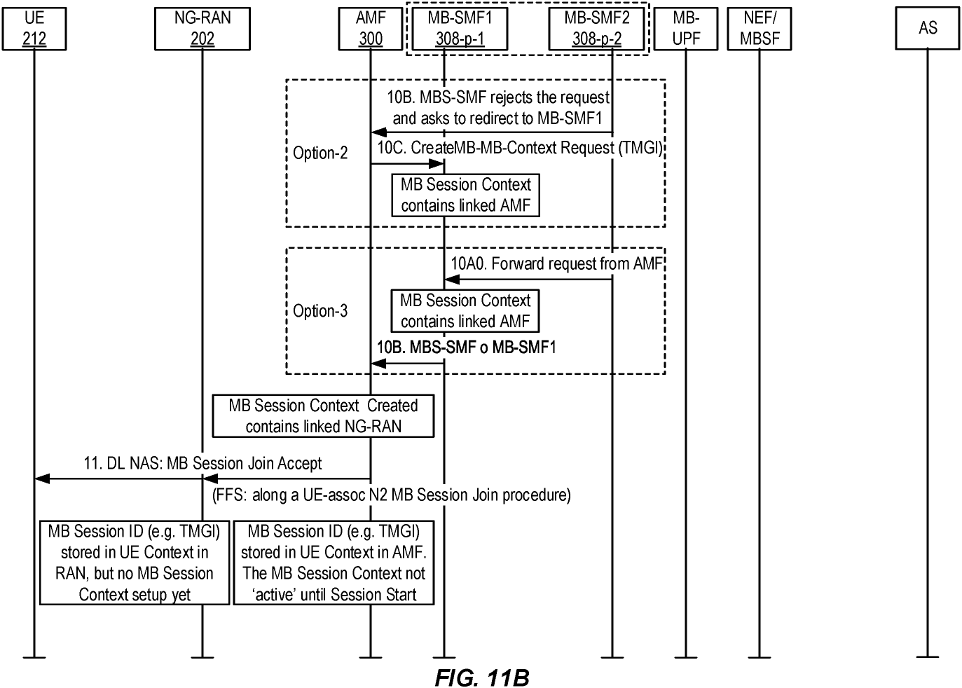

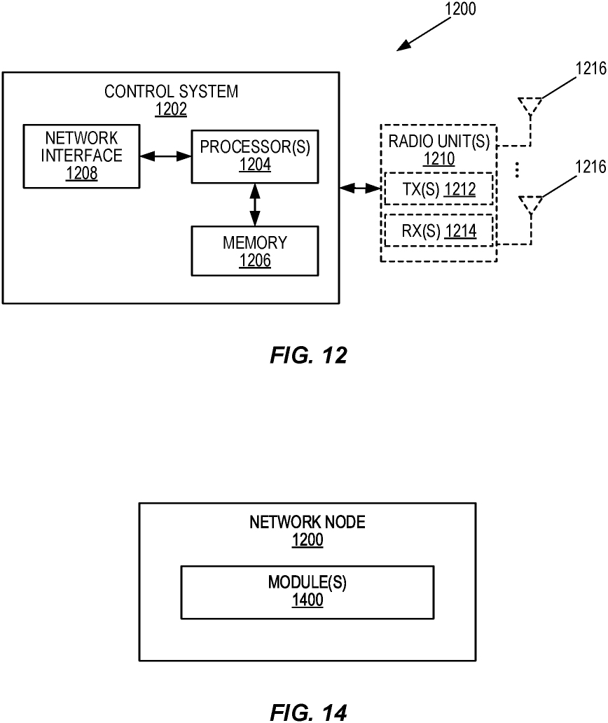

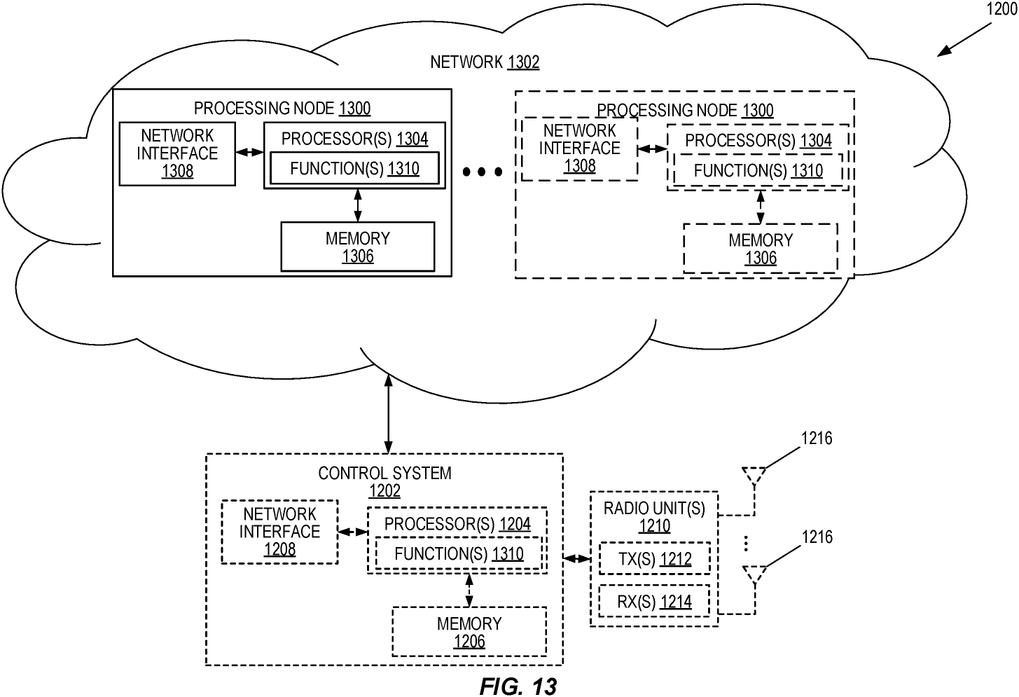

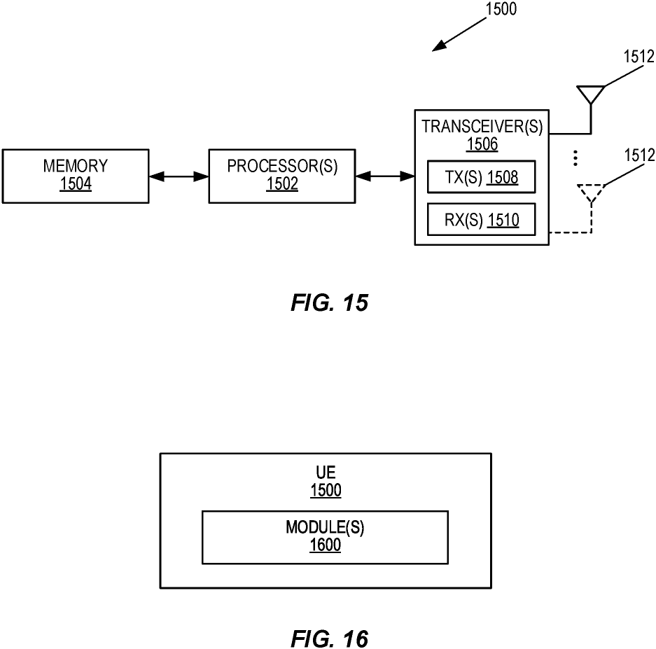

There are problems with existing solutions for joining a multicast group and starting a multicast broadcast session in 5GS. First, the existing solutions do not provide a solution for how the AMF discovers the MB-SMF (see, e.g., step 6 of the procedure illustrated in FIG. 1.

Furthermore, there may be different deployment scenarios, e.g.
one TMGI may be associated with one MB-SMF, or
one TMGI is associated with multiple MB-SMF instance(s) for load balancing or redundancy purpose.
In the case that one TMGI is associated with multiple MB-SMF instances, the AMF needs to be able to know the MB-SMF instance that has allocated the TMGI, otherwise, the AMF cannot further execute the procedure and create an MB Session Context.

Solutions to the aforementioned or other problems are disclosed herein. Solutions are proposed herein that provide several alternatives for how an AMF can perform discovery of a proper MB-SMF or MB-SMF instance in the network. These alternatives include:
1. MB-SMF instances and the associated TMGI ranges are configured in AMFs.
2. MB-SMF pools and the associated TMGI ranges are configured in AMFs.
3. MB-SMF instances and the associated TMGI ranges are registered towards NRF. AMF performs the NF Discovery Request towards NRF to get the right MB-SMF instance.
4. MB-SMF pools and the associated TMGI ranges are registered towards NRF. AMF performs the NF Discovery Request towards NRF to get the MB-SMF pool and then selects one MB-SMF instance.
5. MB-SMF instances register a TMGI towards NRF when the TMGI is allocated. AMF performs the NF Discovery Request towards NRF to get the right MB-SMF instance.
6. MB-SMF instances register a TMGI towards NRF when the TMGI is allocated. AMF performs the NF Discovery Request towards NRF to get the MB-SMF pool and then selects one MB-SMF instance.

The proposed solutions enable multiple MB-SMF instances to be deployed in the network. Without the multiple MB-SMF instance deployment possibility, the MB-SMF will be the bottleneck of the 5MBS, and the capacity will be limited. Based on the proposed solutions, the AMF is able to use the proper MB-SMF instance when UE is going to join the session.

In some embodiments, an MB-SMF pool (i.e., a pool of MB-SMF instances) aspect to deal with the scalability issue of the MB-SMF in 5GC.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 is a reproduction of Figure 6.2.2.1-1 of the Third Generation Partnership Project (3GPP) Technical Report (TR) 23.757 V0.3.0;

FIG. 2 illustrates one example of a cellular communications system according to some embodiments of the present disclosure;

FIGS. 3 and 4 illustrate example embodiments of the cellular communications system of FIG. 2 as a Fifth Generation System (5GS);

FIG. 5 illustrates a Multicast Broadcast (MB) Service (MBS) Session Join procedure;

FIG. 6 illustrates different deployment scenarios;

FIG. 7 illustrates a procedure performed by an Access and Mobility Management Function (AMF) for MB Session Management Function (MB-SMF) discovery and selection during the MBS Session Join procedure of FIG. 5 in accordance with some embodiments of the present disclosure;

FIG. 8 illustrates a procedure performed by an AMF for MB-SMF discovery and selection during the MBS Session Join procedure of FIG. 5 in accordance with some other embodiments of the present disclosure;

FIG. 9 describes solutions for information synchronization to enable the MB-SMF pool in AMF local selection;

FIGS. 10A and 10B illustrate solutions for information synchronization upon reception of AMF request to set up MBS session;

FIGS. 11A and 11B illustrate other solutions for information synchronization upon reception of AMF request to set up MBS session;

FIG. 12 is a schematic block diagram of a network node according to some embodiments of the present disclosure;

FIG. 13 is a schematic block diagram that illustrates a virtualized embodiment of the network node of FIG. 12 according to some embodiments of the present disclosure;

FIG. 14 is a schematic block diagram of the network node of FIG. 12 according to some other embodiments of the present disclosure;

FIG. 15 is a schematic block diagram of a User Equipment device (UE) according to some embodiments of the present disclosure; and

FIG. 16 is a schematic block diagram of the UE of FIG. 15 according to some other embodiments of the present disclosure.

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

Radio Node: As used herein, a “radio node” is either a radio access node or a wireless communication device.

Radio Access Node: As used herein, a “radio access node” or “radio network node” or “radio access network node” is any node in a Radio Access Network (RAN) of a cellular communications network that operates to wirelessly transmit and/or receive signals. Some examples of a radio access node include, but are not limited to, a base station (e.g., a New Radio (NR) base station (gNB) in a Third Generation Partnership Project (3GPP) Fifth Generation (5G) NR network or an enhanced or evolved Node B (eNB) in a 3GPP Long Term Evolution (LTE) network), a high-power or macro base station, a low-power base station (e.g., a micro base station, a pico base station, a home eNB, or the like), a relay node, a network node that implements part of the functionality of a base station or a network node that implements a gNB Distributed Unit (gNB-DU)) or a network node that implements part of the functionality of some other type of radio access node.

Core Network Node: As used herein, a “core network node” is any type of node in a core network or any node that implements a core network function. Some examples of a core network node include, e.g., a Mobility Management Entity (MME), a Packet Data Network Gateway (P-GW), a Service Capability Exposure Function (SCEF), a Home Subscriber Server (HSS), or the like. Some other examples of a core network node include a node implementing a Access and Mobility Management Function (AMF), a User Plane Function (UPF), a Session Management Function (SMF), an Authentication Server Function (AUSF), a Network Slice Selection Function (NSSF), a Network Exposure Function (NEF), a Network Function (NF) Repository Function (NRF), a Policy Control Function (PCF), a Unified Data Management (UDM), or the like.

Communication Device: As used herein, a “communication device” is any type of device that has access to an access network. Some examples of a communication device include, but are not limited to: mobile phone, smart phone, sensor device, meter, vehicle, household appliance, medical appliance, media player, camera, or any type of consumer electronic, for instance, but not limited to, a television, radio, lighting arrangement, tablet computer, laptop, or Personal Computer (PC). The communication device may be a portable, hand-held, computer-comprised, or vehicle-mounted mobile device, enabled to communicate voice and/or data via a wireless or wireline connection.

Wireless Communication Device: One type of communication device is a wireless communication device, which may be any type of wireless device that has access to (i.e., is served by) a wireless network (e.g., a cellular network). Some examples of a wireless communication device include, but are not limited to: a User Equipment device (UE) in a 3GPP network, a Machine Type Communication (MTC) device, and an Internet of Things (IoT) device. Such wireless communication devices may be, or may be integrated into, a mobile phone, smart phone, sensor device, meter, vehicle, household appliance, medical appliance, media player, camera, or any type of consumer electronic, for instance, but not limited to, a television, radio, lighting arrangement, tablet computer, laptop, or PC. The wireless communication device may be a portable, hand-held, computer-comprised, or vehicle-mounted mobile device, enabled to communicate voice and/or data via a wireless connection.

Network Node: As used herein, a “network node” is any node that is either part of the RAN or the core network of a cellular communications network/system.

Note that the description given herein focuses on a 3GPP cellular communications system and, as such, 3GPP terminology or terminology similar to 3GPP terminology is oftentimes used. However, the concepts disclosed herein are not limited to a 3GPP system.

Network Function and Network Function Instance: As used herein, the term “NF instance” (e.g., MB-SMF instance) is used to refer to multiple instances of the same NF used for load balancing or redundancy.

Note that, in the description herein, reference may be made to the term “cell”; however, particularly with respect to 5G NR concepts, beams may be used instead of cells and, as such, it is important to note that the concepts described herein are equally applicable to both cells and beams.

### Figure 2

FIG. 2 illustrates one example of a cellular communications system 200 in which embodiments of the present disclosure may be implemented. In the embodiments described herein, the cellular communications system 200 is a 5G System (5GS) including a Next Generation RAN (NG-RAN) and a 5G Core (5GC). In this example, the RAN includes base stations 202-1 and 202-2, which in the 5GS include NR base stations (gNBs) and optionally next generation eNBs (ng-eNBs) (i.e., LTE RAN nodes connected to the 5GC), controlling corresponding (macro) cells 204-1 and 204-2. The base stations 202-1 and 202-2 are generally referred to herein collectively as base stations 202 and individually as base station 202. Likewise, the (macro) cells 204-1 and 204-2 are generally referred to herein collectively as (macro) cells 204 and individually as (macro) cell 204. The RAN may also include a number of low power nodes 206-1 through 206-4 controlling corresponding small cells 208-1 through 208-4. The low power nodes 206-1 through 206-4 can be small base stations (such as pico or femto base stations) or Remote Radio Heads (RRHs), or the like. Notably, while not illustrated, one or more of the small cells 208-1 through 208-4 may alternatively be provided by the base stations 202. The low power nodes 206-1 through 206-4 are generally referred to herein collectively as low power nodes 206 and individually as low power node 206. Likewise, the small cells 208-1 through 208-4 are generally referred to herein collectively as small cells 208 and individually as small cell 208. The cellular communications system 200 also includes a core network 210, which in the 5GS is referred to as the 5G Core (5GC). The base stations 202 (and optionally the low power nodes 206) are connected to the core network 210.

The base stations 202 and the low power nodes 206 provide service to wireless communication devices 212-1 through 212-5 in the corresponding cells 204 and 208. The wireless communication devices 212-1 through 212-5 are generally referred to herein collectively as wireless communication devices 212 and individually as wireless communication device 212. In the following description, the wireless communication devices 212 are oftentimes UEs, but the present disclosure is not limited thereto.

### Figure 3

FIG. 3 illustrates a wireless communication system represented as a 5G network architecture composed of core Network Functions (NFs), where interaction between any two NFs is represented by a point-to-point reference point/interface. FIG. 3 can be viewed as one particular implementation of the system 200 of FIG. 2.

Seen from the access side the 5G network architecture shown in FIG. 3 comprises a plurality of UEs 212 connected to either a RAN 202 or an Access Network (AN) as well as an AMF 300. Typically, the R(AN) 202 comprises base stations, e.g. such as eNBs or gNBs or similar. Seen from the core network side, the 5GC NFs shown in FIG. 3 include a NSSF 302, an AUSF 304, a UDM 306, the AMF 300, a SMF 308, a PCF 310, and an Application Function (AF) 312.

Reference point representations of the 5G network architecture are used to develop detailed call flows in the normative standardization. The N1 reference point is defined to carry signaling between the UE 212 and AMF 300. The reference points for connecting between the AN 202 and AMF 300 and between the AN 202 and UPF 314 are defined as N2 and N3, respectively. There is a reference point, N11, between the AMF 300 and SMF 308, which implies that the SMF 308 is at least partly controlled by the AMF 300. N4 is used by the SMF 308 and UPF 314 so that the UPF 314 can be set using the control signal generated by the SMF 308, and the UPF 314 can report its state to the SMF 308. N9 is the reference point for the connection between different UPFs 314, and N14 is the reference point connecting between different AMFs 300, respectively. N15 and N7 are defined since the PCF 310 applies policy to the AMF 300 and SMF 308, respectively. N12 is required for the AMF 300 to perform authentication of the UE 212. N8 and N10 are defined because the subscription data of the UE 212 is required for the AMF 300 and SMF 308.

The 5GC network aims at separating UP and CP. The UP carries user traffic while the CP carries signaling in the network. In FIG. 3, the UPF 314 is in the UP and all other NFs, i.e., the AMF 300, SMF 308, PCF 310, AF 312, NSSF 302, AUSF 304, and UDM 306, are in the CP. Separating the UP and CP guarantees each plane resource to be scaled independently. It also allows UPFs to be deployed separately from CP functions in a distributed fashion. In this architecture, UPFs may be deployed very close to UEs to shorten the Round Trip Time (RTT) between UEs and data network for some applications requiring low latency.

The core 5G network architecture is composed of modularized functions. For example, the AMF 300 and SMF 308 are independent functions in the CP. Separated AMF 300 and SMF 308 allow independent evolution and scaling. Other CP functions like the PCF 310 and AUSF 304 can be separated as shown in FIG. 3. Modularized function design enables the 5GC network to support various services flexibly.

Each NF interacts with another NF directly. It is possible to use intermediate functions to route messages from one NF to another NF. In the CP, a set of interactions between two NFs is defined as service so that its reuse is possible. This service enables support for modularity. The UP supports interactions such as forwarding operations between different UPFs.

### Figure 4

FIG. 4 illustrates a 5G network architecture using service-based interfaces between the NFs in the CP, instead of the point-to-point reference points/interfaces used in the 5G network architecture of FIG. 3. However, the NFs described above with reference to FIG. 3 correspond to the NFs shown in FIG. 4. The service(s) etc. that a NF provides to other authorized NFs can be exposed to the authorized NFs through the service-based interface. In FIG. 4 the service based interfaces are indicated by the letter “N” followed by the name of the NF, e.g. Namf for the service based interface of the AMF 300 and Nsmf for the service based interface of the SMF 308, etc. The NEF 400 and the NRF 402 in FIG. 4 are not shown in FIG. 3 discussed above. However, it should be clarified that all NFs depicted in FIG. 3 can interact with the NEF 400 and the NRF 402 of FIG. 4 as necessary, though not explicitly indicated in FIG. 3.

Some properties of the NFs shown in FIGS. 3 and 4 may be described in the following manner. The AMF 300 provides UE-based authentication, authorization, mobility management, etc. A UE 212 even using multiple access technologies is basically connected to a single AMF 300 because the AMF 300 is independent of the access technologies. The SMF 308 is responsible for session management and allocates Internet Protocol (IP) addresses to UEs. It also selects and controls the UPF 314 for data transfer. If a UE 212 has multiple sessions, different SMFs 308 may be allocated to each session to manage them individually and possibly provide different functionalities per session. The AF 312 provides information on the packet flow to the PCF 310 responsible for policy control in order to support QoS. Based on the information, the PCF 310 determines policies about mobility and session management to make the AMF 300 and SMF 308 operate properly. The AUSF 304 supports authentication function for UEs or similar and thus stores data for authentication of UEs or similar while the UDM 306 stores subscription data of the UE 212. The Data Network (DN), not part of the 5GC network, provides Internet access or operator services and similar.

An NF may be implemented either as a network element on a dedicated hardware, as a software instance running on a dedicated hardware, or as a virtualized function instantiated on an appropriate platform, e.g., a cloud infrastructure.

Now a description of some solutions disclosed herein are provided. While described separated, one or more of these solutions or the particular embodiments or aspects of these solutions can be used in combination.

### 1 Procedure of MBS Session Join in 5MBS

### Figure 5

FIG. 5 illustrates the MBS Session Join procedure in 5MBS.

The acronyms “MBS” (Multicast Broadcast Service) and “MB” (Multicast Broadcast) are used interchangeable as prefixes in the descriptions below.

The proposed solutions include and potentially consist of the following aspects:
Solutions are proposed herein for how the AMF 300 that supports MBS discovers and selects the appropriate SMF instance (referred to as the “MB-SMF” or “MB-SMF instance” in this context) in step 9 of FIG. 5.
Solutions are proposed herein for how to coordinate MB-SMF instances selected by the AS in step 2 of FIG. 5 and by the AMF 300 in step 9 if one TMGI is associated with multiple MB-SMF instances.

### 2 AMF Discovering and Selecting MB-SMF in Different Deployment Scenarios

### 2.1 Possible MB-SMF Deployment Scenarios

### Figure 6

As illustrated in FIG. 6, in the 5G MBS network, there may be different deployment scenarios, typically:
Deployment-1: One TMGI range is associated with one MB-SMF (may also be referred to as one MB-SMF instance). There shouldn’t be overlapping between the TMGI ranges associated with different MB-SMFs (or different MB-SMF instances).
Deployment-2: One TMGI range is associated with multiple MB-SMF instances in a MB-SMF pool (e.g. 3 in the example of FIG. 6). Within a MB-SMF pool, the MB-SMF instances share the same TMGI range (i.e. full overlapping and no partial overlapping). In the example of FIG. 6, a first TMGI range (TMGI 1-2) is associated with a first MB-SMF 308-1 (denoted as SMF1), and a second TMGI range (TMGI 2-3) is associated with a set of MB-SMF instances in a MB-SMF pool. In the illustrated example, the set of MB-SMF instances in the MB-SMF pool consists of a first MB-SMF instance 308-2-1 (denoted as SMF2-1), a second MB-SMF instance 308-2-2 (denoted as SMF2-2), and a third MB-SMF instance 308-2-3 (denoted as SMF2-3).

The 5MBS service and the 5G MB Session can be identified by the Temporary Mobile Group Identity (TMGI). In this case, when performing service discovery, the AMF 300 can discover the MB-SMF instance based on the TMGI of the service. TMGI consists of three parts: MCC (Mobile Country Code), MNC (Mobile Network Code), and service ID. It is also possible to apply the solution to the service ID part of the TMGI, instead of the whole TMGI (i.e., define the service ID range, instead of TMGI range).

The 5MBS service and the 5G MB Session can also be possible to be identified by other identifiers, for example, the destination IP multicast address (MB-UPF deliver the user plane packets to the destination IP multicast address to NG-RAN) with or without UDP port. This is not illustrated in FIG. 6. Thus, a “resource identifier” (e.g., TMGI, service ID, IP multicast address, UDP port, or session ID (e.g., “MB Session ID”, “Multicast Session Id”, etc.) could replace the “TMGI” throughout this text. In general, this resource identifier is an identifier that is associated with and/or identifies a data flow / data stream that is transmitted or will be transmitted to each UE in a group of UEs that participate or will participate in a multicast (point-to-multipoint) group communication. Examples of this resource identifier are given above, but these examples are only examples and do not limit the scope of the term “resource identifier”.

### 2.3 AMF Discovering/Selecting MB-SMF Based on Local Configuration in AMF

As illustrated in FIG. 6, the association between TMGI range and MB-SMF(s) and/or MB-SMF instance(s) can be locally configured in the AMF 300. In this case, the AMF 300 discovers and selects an MB-SMF or MB-SMF instance from its local configuration. This discovery and selection is performed in, e.g., step 9 of the process of FIG. 5.

### Figure 7

For example, FIG. 7 illustrates a process performed by the AMF 300 for discovery and selection of an MB-SMF, e.g., in step 9 of FIG. 5. As illustrated, the AMF 300 discovers a set of MB-SMF instances based on its local configuration (steps 700 and 700A) and selects an MB-SMF instance from the discovered set of MB-SMF instances (step 702).

### 2.4 AMF Discovering/Selecting MB-SMF(s) by Querying the NRF

This requires that MB-SMF needs to register themselves in the NRF, there could be two options regarding when MB-SMF can register itself into NRF:
Option-1: Each MB-SMF instance (e.g., each of the MB-SMF instances 308-2-1, 308-2-2, and 308-2-3 in the MB-SMF pool of FIG. 6) registers itself into the NRF 402 once the MB-SMF instance is ready for providing service (as for other NF service providers). In this option, the MB-SMF instance would register itself together its TMGI range to the NRF 402. In MB-SMF discovery (in step 9 of FIG. 5), the AMF 300 performs NFDiscovery to the NRF 402 with the TMGI received from the UE 202 (e.g., during step 7 of FIG. 5), and the NRF 402 responds to the AMF 402 with information that identifies the MB-SMF instance(s) (e.g., MB-SMF instance IDs) whose TMGI range contains the TMGI provided by the AMF 402. This option is illustrated in FIG. 7, particularly in steps 700B, 700C, and 702.
Option-2: Each MB-SMF instance (e.g., each of the MB-SMF instances 308-2-1, 308-2-2, and 308-2-3 in the MB-SMF pool of FIG. 6) registers itself into the NRF 402 when a request from the AS is received to allocate TMGI (in step 1 of FIG. 5). In this option, the MB-SMF instance registers itself together with its allocated TMGI to the NRF 402. In the MB-SMF discovery (in step 9 of FIG. 5), the AMF 300 performs NFDiscovery to the NRF 402 with the TMGI received from the UE 212 (e.g., in step 7 of FIG. 5), and the NRF 402 responds to the AMF 300 information that identifies the MB-SMF instance(s) (e.g., MB-SMF instance IDs) who have allocated the TMGI.

### Figure 8

This is illustrated in FIG. 8, which illustrates a process performed by the AMF 300 for MB-SMF instance discovery and selection, e.g., according to Option-2. As illustrated, the AMF 300 sends a discovery request to the NRF 402, where the discovery request includes the desired resource identifier (e.g., TMGI in the described example) (step 800). The AMF 300 receives a response from the NRF 400 that includes information that identifies a set of MB-SMF instances that satisfy the discovery request (step 802) and then selects a MB-SMF instance from the discovered set of MB-SMF instances (step 804).

In the registration towards NRF option, in the NF discovery phase, besides the MB-SMF instance(s), the NRF 402 could include other associated optional information (e.g. load information). In one embodiment, the AMF 300 performs MB-SMF selection based on this associated optional information (e.g., the AMF 300 can select the less loaded MB-SMF instance).

### 3 How to Coordinate the MB-SMF Instances Selected by the AMF and by AS

Several solutions are proposed below.

### 3.1 Synchronization Within MB-SMF Pool Without AMF’s Awareness

### Figure 9

FIG. 9 describes a solution of the information synchronization to enable the MB-SMF pool in AMF local selection. In the example embodiment of FIG. 9, two MB-SMF instances, denoted as MB-SMF1 and MB-SMF2, are within the same MB-SMF pool. MB-SMF1 is also referenced herein as MB-SMF 308-p-1 and MB-SMF2 is also referenced herein as MB-SMF 108-p-1, where “p” denotes a MB-SMF pool p.

In step 3A, after MB-SMF1 allocates resources for the MBS Session, MB-SMF1 synchronizes the MB Session information towards other pool members, which include MB-SMF2 in this example. After the synchronization step, the MB Session Contexts are created in both MB-SMF1 and MB-SMF2.

In step 9, when performing MB-SMF selection, the AMF 300 compares the TMGI it receives in the MB Session Join Request sent by the UE 212 with the TMGI ranges configured locally to determine the MB-SMF instance(s) that match the given TMGI from the MB Session Join Request. Alternatively, the AMF 300 queries the NRF 402 to get proper MB-SMF instance(s) whose TMGI range contains the given TMGI from the MB Session Join Request. Once the AMF 300 has discovered the MB-SMF instance(s), the AMF 300 selects one of the discovered MB-SMF instances. During MB-SMF discovery, the AMF 300 may obtain information that identifies the MB-SMF instance(s) or information that identifies a MB-SMF pool. If the AMF 300 obtains information that identifies the MB-SMF instance(s) (e.g., a list of MB-SMF instances), the AMF 300 selects one of the MB-SMF instances from the list. If the AMF 300 obtains information that identifies a MB-SMF pool, the AMF 300 selects an MB-SMF instance from the identified MB-SMF pool. Here it’s assumed MB-SMF2 is selected, which is different from the AS selected MB-SMF (i.e., different from the MB-SMF instances to which the allocate TMGI request was sent in step 2 of FIG. 9).

In step 10, the AMF 300 sends a Create MB Session Context request to MB-SMF2. The MB-SMF2 has already received the MBS Session information for the TMGI in step 3A. In this example, the AMF 300 receives the requested information from MB-SMF2.

In step 10A, MB-SMF2 updates the MB Session Context with the linked AMF information (i.e., with information about the AMF 300). Also, MB-SMF2 synchronizes the updated session information towards other pool members, which include the MB-SMF1 in this example, so that the pool members are always synchronized with each other. After that, MB-SMF1 also has a MB Session Context that is updated with the linked AMF information.

### 3.2 AMF Updated With the AS Selected MB-SMF

### 3.2.1 Locating the “Right” MB-SMF at AMF Request

### Figures 10A and 10B

FIGS. 10A and 10B illustrate a solution option of the information synchronization upon reception of AMF request to set up MBS session. In FIGS. 10A and 10B, MB-SMF1 and MB-SMF2 are within the same MB-SMF pool. Again, MB-SMF1 is also referenced herein as MB-SMF 308-p-1 and MB-SMF2 is also referenced herein as MB-SMF 108-p-1, where “p” denotes a MB-SMF pool p.

In step 3, MB-SMF1 is used to allocate resources for the MBS Session.

In step 9, the AMF 300 performs MB-SMF selection based on local configuration or by querying the NRF 402, and the AMF 402 selects MB-SMF2 in this example, which is different from the AS selected MB-SMF.

In step 10, the AMF 300 sends Create MB Session Context request to MB-SMF2.

In step 10A, as MB-SMF2 does not have the MBS Session information for the TMGI, it queries its pool member who is the owner of the session (i.e. who has created the session). In this example, the MB-SMF1 has the information and is thus the owner of the session.

Option-1:
Within Step 10A, MB-SMF1 updates the MB Session Context with the linked AMF (i.e., with information about the AMF 300).
In step 10B, MB-SMF2 accepts the request but pretends to be the MB-SMF1. MB-SMF2 requests the AMF 300 to update itself with information of MB-SMF1.

Option-2:
In step 10B, MB-SMF2 rejects the request and asks to redirect the request to MB-SMF1.
In step 10C, the AMF 300 sends a Create MB Session Context request to MB-SMF1. MB-SMF1 updates the MB Session Context with the linked AMF (i.e., with information about the AMF 300).

Option-3:
In step 10A0, MB-SMF2 forwards the request from the AMF 300 to the “right” MB-SMF (i.e. MB-SMF1). MB-SMF1 updates the MB Session Context with the linked AMF (i.e., with information about the AMF 300).
In step 10B, MB-SMF1 accepts the request and responds to the AMF 300.

### 3.2.2 MB-SMF Instances in the Pool Aware of Each Other’s MBS Session at TMGI Allocation

### Figures 11A and 11B

This embodiment is illustrated in FIGS. 11A and 11B. The difference compared to the embodiment of FIGS. 10A and 10B is that the embodiment of FIGS. 11A and 11B does MBS Session synchronization earlier at TMGI allocation (i.e. step 3A), which mean that step 10A in the embodiment of FIGS. 10A and 10B is not needed.

Option-1 in the embodiment of FIGS. 10A and 10B is not applicable. That is, in step 3A in the embodiment of FIGS. 11A and 11B, MB-SMF1 inform other pool members that it has created the MBS session, so that in step 10B, MB-SMF2 can take appropriate actions. Thus, it is not necessary to have the step 10A of the embodiment 10A and 10B to query pool members. That is, either the create request from the AMF in step 10 does not succeed (Option 2) or the firstly requested MB-SMF (e.g. MB SMF1) will be able to successfully redirect (Option 3) the create request to the relevant MB-SMF in the pool, step 10A0, which relevant MB-SMF will then be able to respond to the AMF.

### 4 Additional Aspects Applicable to All Embodiments Above

### Figure 12

FIG. 12 is a schematic block diagram of a network node 1200 according to some embodiments of the present disclosure. Optional features are represented by dashed boxes. The network node 1200 may be, for example, a network node that implements a core network function (e.g., a MB-SMF or MB-SMF instance, AMF 300, etc.) or a base station 202 or 206. As illustrated, the network node 1200 includes a control system 1202 that includes one or more processors 1204 (e.g., Central Processing Units (CPUs), Application Specific Integrated Circuits (ASICs), Field Programmable Gate Arrays (FPGAs), and/or the like), memory 1206, and a network interface 1208. The one or more processors 1204 are also referred to herein as processing circuitry. In addition, if the network node 1200 is a radio access node (e.g., a base station 202 or low power node 206), the network node 1200 may also include one or more radio units 1210 that each includes one or more transmitters 1212 and one or more receivers 1214 coupled to one or more antennas 1216. The radio units 1210 may be referred to or be part of radio interface circuitry. In some embodiments, the radio unit(s) 1210 is external to the control system 1202 and connected to the control system 1202 via, e.g., a wired connection (e.g., an optical cable). However, in some other embodiments, the radio unit(s) 1210 and potentially the antenna(s) 1216 are integrated together with the control system 1202. The one or more processors 1204 operate to provide one or more functions of the network node 1200 as described herein (e.g., one or more functions of a base station 202, AMF 302, MB-SMF or MB-SMF instance as described herein). In some embodiments, the function(s) are implemented in software that is stored, e.g., in the memory 1206 and executed by the one or more processors 1204.

### Figure 13

FIG. 13 is a schematic block diagram that illustrates a virtualized embodiment of the network node 1200 according to some embodiments of the present disclosure. As used herein, a “virtualized” network node is an implementation of the network node 1200 in which at least a portion of the functionality of the network node 1200 is implemented as a virtual component(s) (e.g., via a virtual machine(s) executing on a physical processing node(s) in a network(s)). As illustrated, in this example, the network node 1200 includes one or more processing nodes 1300 coupled to or included as part of a network(s) 1302. Each processing node 1300 includes one or more processors 1304 (e.g., CPUs, ASICs, FPGAs, and/or the like), memory 1306, and a network interface 1308. If the network node 1200 is a radio access node, the network node 1200 may include the control system 1202 and/or the one or more radio units 1210, as described above.

In this example, functions 1310 of the network node 1200 described herein (e.g., one or more functions of a base station 202, AMF 302, MB-SMF or MB-SMF instance as described herein) are implemented at the one or more processing nodes 1300 or distributed across the one or more processing nodes 1300 and the control system 1202 and/or the radio unit(s) 1210 in any desired manner. In some particular embodiments, some or all of the functions 1310 of the network node 1200 described herein (e.g., one or more functions of a base station 202, AMF 302, MB-SMF or MB-SMF instance as described herein) are implemented as virtual components executed by one or more virtual machines implemented in a virtual environment(s) hosted by the processing node(s) 1300.

In some embodiments, a computer program including instructions which, when executed by at least one processor, causes the at least one processor to carry out the functionality of the network node 1200 or a node (e.g., a processing node 1300) implementing one or more of the functions 1310 of the network node 1200 in a virtual environment according to any of the embodiments described herein (e.g., one or more functions of a base station 202, AMF 302, MB-SMF or MB-SMF instance as described herein) is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

### Figure 14

FIG. 14 is a schematic block diagram of the network node 1200 according to some other embodiments of the present disclosure. The network node 1200 includes one or more modules 1400, each of which is implemented in software. The module(s) 1400 provide the functionality of the network node 1200 described herein (e.g., one or more functions of a base station 202, AMF 302, MB-SMF or MB-SMF instance as described herein). This discussion is equally applicable to the processing node 1300 of FIG. 13 where the modules 1400 may be implemented at one of the processing nodes 1300 or distributed across multiple processing nodes 1300 and/or distributed across the processing node(s) 1300 and the control system 1202.

### Figure 15

FIG. 15 is a schematic block diagram of a wireless communication device 1500 according to some embodiments of the present disclosure. As illustrated, the wireless communication device 1500 includes one or more processors 1502 (e.g., CPUs, ASICs, FPGAs, and/or the like), memory 1504, and one or more transceivers 1506 each including one or more transmitters 1508 and one or more receivers 1510 coupled to one or more antennas 1512. The transceiver(s) 1506 includes radio-front end circuitry connected to the antenna(s) 1512 that is configured to condition signals communicated between the antenna(s) 1512 and the processor(s) 1502, as will be appreciated by on of ordinary skill in the art. The processors 1502 are also referred to herein as processing circuitry. The transceivers 1506 are also referred to herein as radio circuitry. In some embodiments, the functionality of the wireless communication device 1500 described above may be fully or partially implemented in software that is, e.g., stored in the memory 1504 and executed by the processor(s) 1502. Note that the wireless communication device 1500 may include additional components not illustrated in FIG. 15 such as, e.g., one or more user interface components (e.g., an input/output interface including a display, buttons, a touch screen, a microphone, a speaker(s), and/or the like and/or any other components for allowing input of information into the wireless communication device 1500 and/or allowing output of information from the wireless communication device 1500), a power supply (e.g., a battery and associated power circuitry), etc.

In some embodiments, a computer program including instructions which, when executed by at least one processor, causes the at least one processor to carry out the functionality of the wireless communication device 1500 according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

### Figure 16

FIG. 16 is a schematic block diagram of the wireless communication device 1500 according to some other embodiments of the present disclosure. The wireless communication device 1500 includes one or more modules 1600, each of which is implemented in software. The module(s) 1600 provide the functionality of the wireless communication device 1500 described herein.

Some embodiments described above may be summarized in the following manner:
1. A method of operation of an Access and Mobility Management Function, AMF, (300) for a core network (210) of a cellular communications system (200) for a multicast/broadcast, MB, session join procedure, the method comprising:
   receiving (FIG. 5, step 7; FIG. 9, step 7) a MB session join request from a wireless communication device (200);
   selecting (FIG. 5, step 9; FIG. 9, step 9) a MB Session Management Function, MB-SMF, instance from a set of MB-SMF instances associated with a particular resource identifier that is associated with and/or identifies a data flow or data stream that is transmitted or will be transmitted to each wireless communication devices in a group of wireless communication devices that participate or will participate in the MB session; and
   continuing (FIG. 5, steps 10-11; FIG. 9, steps 10-11) the MB session join procedure using the selected MB-SMF instance.
2. The method of embodiment 1 wherein the set of MB-SMF instances comprises two or more MB-SMF instances each associated with a same set of resource identifiers that comprises the particular resource identifier.
3. The method of embodiment 2 wherein the same set of resource identifiers is a same range of resource identifiers.
4. The method of embodiment 2 or 3 wherein the set of MB-SMF instances consists of two or more MB-SMF instances in a MB-SMF pool that is associated with the same set of resource identifiers.
5. The method of any one of embodiment 2 to 4 wherein selecting (FIG. 5, step 9; FIG. 9, step 9) the MB-SMF instance from the set of MB-SMF instances comprises:
   discovering (700) the set of MB-SMF instances; and
   selecting (702) the selected MB-SMF instance from the discovered set of MB-SMF instances.
6. The method of embodiment 5 wherein discovering (700) the set of MB-SMF instances comprises discovering (700A) the set of MB-SMF instances based on a local configuration of an association between the same set of resource identifiers and the set of MB-SMF instances.
7. The method of embodiment 5 wherein discovering (700) the set of MB-SMF instances comprises:
   sending (700B) a discovery request to a Network Repository Function, NRF, (402), the discovery request comprising the particular resource identifier; and
   receiving (700C) a response from the NRF (402) that comprises information that identifies the set of MB-SMFs instances.
8. The method of embodiment 1 wherein selecting (FIG. 5, step 9; FIG. 9, step 9) the MB-SMF instance from the set of MB-SMF instances comprises:
   sending (800) a discovery request to a Network Repository Function, NRF, (402), the discovery request comprising the particular resource identifier;
   receiving (802) a response from the NRF (402) that comprises information that identifies one or more MB-SMFs instances; and
   selecting (804) the selected MB-SMF instance from the one or more MB-SMF instances.
9. The method of any one of embodiment 1 to 8 wherein the resource identifier is a TMGI.
10. The method of any one of embodiment 1 to 8 wherein the resource identifier is a service ID, an IP multicast address, a UDP port, or a session ID.
11. The method of any one of embodiment 1 to 10 wherein the particular resource identifier is comprised in the MB session join request received from the wireless communication device (212).
12. A method of operation of a first Multicast/Broadcast, MB, Session Management Function, MB-SMF, instance (308-p-1) for a core network (210) of a cellular communications system (200) for a MB session join procedure, the method comprising:
   allocating (FIG. 9, step 1) resources for a MB session;
   establishing (FIG. 9, step 2) the MB session;
   synchronizing (FIG. 9, step 3) MB session for the MB session stored locally at the first MB-SMF towards one or more additional MB-SMF instances in a same MB-SMF pool.
13. The method of embodiment 12 wherein the resources comprise a resource identifier that is associated with and/or identifies a data flow or data stream that is transmitted or will be transmitted to each wireless communication devices in a group of wireless communication devices that participate or will participate in the MB session.
14. The method of embodiment 13 wherein the resource identifier is a TMGI.
15. The method of embodiment 13 wherein the resource identifier is a service ID, an IP multicast address, a UDP port, or a session ID.
16. A method of operation of a second Multicast/Broadcast, MB, Session Management Function, MB-SMF, instance (308-p-2) for a core network (210) of a cellular communications system (200) for a MB session join procedure, the method comprising:
   receiving (FIG. 9, step 3) MB session information for a MB session from a first MB-SMF instance (308-p-2) that is in a same MB-SMF pool;
   storing (FIG. 9, step 3) the received MB session information for the MB session.
17. The method of embodiment 16 wherein the first MB-SMF instance (308-p-1) is a MB-SMF instance that allocated resources for the MB session.
18. The method of embodiment 17 wherein the resources comprise a resource identifier that is associated with and/or identifies a data flow or data stream that is transmitted or will be transmitted to each wireless communication devices in a group of wireless communication devices that participate or will participate in the MB session.
19. The method of embodiment 18 wherein the resource identifier is a TMGI.
20. The method of embodiment 18 wherein the resource identifier is a service ID, an IP multicast address, a UDP port, or a session ID.
21. The method of any one of embodiment 16 to 20 further comprising:
   receiving (FIG. 9, step 10) a create MB session context request from an Access and Mobility Management Function, AMF, (300) as part of a MB session join procedure;
   providing (FIG. 9, step 10A) updated MB session information to one or more other MB-SMF instances in the same MB-SMF pool, wherein:
      the one or more other MB-SMF instances comprises the first MB-SMF instance (308-p-1); and
      the updated MB session information comprises information about the AMF (300).
22. A method of operation of an Access and Mobility Management Function, AMF, (300) for a core network (210) of a cellular communications system (200) for a multicast/broadcast, MB, session join procedure, the method comprising:
   receiving (FIG. 10A, step 7; FIG. 11A, step 7) a MB session join request from a wireless communication device (200);
   selecting (FIG. 10A, step 9; FIG. 11A, step 9) a MB Session Management Function, MB-SMF, instance;
   sending (FIG. 10A, step 10; FIG. 11A, step 10) a create MB context request to the selected MB-SMF instance;
   receiving (FIG. 10B, step 10B; FIG. 11B, step 10B) a message from the selected MB-SMF that requests the create MB context request and redirects the AMF (300) to a second MB-SMF instance in a same MB-SMF pool;
   sending (FIG. 10B, step 10C; FIG. 11B, step 10C) a create MB context request to the second MB-SMF instance.
23. A method of operation of an Access and Mobility Management Function, AMF, (300) for a core network (210) of a cellular communications system (200) for a multicast/broadcast, MB, session join procedure, the method comprising:
   receiving (FIG. 10A, step 7; FIG. 11A, step 7) a MB session join request from a wireless communication device (200);
   selecting (FIG. 10A, step 9; FIG. 11A, step 9) a MB Session Management Function, MB-SMF, instance;
   sending (FIG. 10A, step 10; FIG. 11A, step 10) a create MB context request to the selected MB-SMF instance; and
   receiving (FIG. 10B, step 10B; FIG. 11B, step 10B) a response to the create MB context request from a second MB-SMF instance in a same MB-SMF pool as the selected MB-SMF instance.
24. A method of operation of Multicast/Broadcast, MB, Session Management Function, MB-SMF, instance (308-p-2) for a core network (210) of a cellular communications system (200) for a multicast/broadcast, MB, session join procedure, the method comprising:
   receiving (FIG. 10A, step 10) a create MB context request from an Access and Mobility Management Function, AMF, (300);
   sending (FIG. 10B, step 10B) a response to the MB context request to the AMF (300) pretending to be another MB-SMF instance (308-p-1) in a same MB-SMF pool as the MB-SMF instance (308-p-2).
25. A method of operation of Multicast/Broadcast, MB, Session Management Function, MB-SMF, instance (308-p-2) for a core network (210) of a cellular communications system (200) for a multicast/broadcast, MB, session join procedure, the method comprising:
   receiving (FIG. 10A, step 10) a create MB context request from an Access and Mobility Management Function, AMF, (300);
   sending (FIG. 10B, step 10B) a message to the AMF (300) that rejects the create MB context request and redirects the AMF (300) to another MB-SMF instance (308-p-1) in a same MB-SMF pool as the MB-SMF instance (308-p-2).

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processors (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

While processes in the figures may show a particular order of operations performed by certain embodiments of the present disclosure, it should be understood that such order is exemplary (e.g., alternative embodiments may perform the operations in a different order, combine certain operations, overlap certain operations, etc.).

At least some of the following abbreviations may be used in this disclosure. If there is an inconsistency between abbreviations, preference should be given to how it is used above. If listed multiple times below, the first listing should be preferred over any subsequent listing(s).

| | |
|---|---|
| 3GPP | Third Generation Partnership Project |
| 5G | Fifth Generation |
| 5GC | Fifth Generation Core |
| 5GS | Fifth Generation System |
| AF | Application Function |
| AMF | Access and Mobility Management Function |
| AN | Access Network |
| AP | Access Point |
| AUSF | Authentication Server Function |
| DN | Data Network |
| gNB | New Radio Base Station |
| HSS | Home Subscriber Server |
| IP | Internet Protocol |
| MB | Multicast Broadcast |
| MBS | Multicast Broadcast Service |
| MTC | Machine Type Communication |
| NEF | Network Exposure Function |
| NF | Network Function |
| NR | New Radio |
| NRF | Network Function Repository Function |
| NSSF | Network Slice Selection Function |
| PCF | Policy Control Function |
| RAN | Radio Access Network |
| SCEF | Service Capability Exposure Function |
| SMF | Session Management Function |
| TMGI | Temporary Mobile Group Identity |
| UDM | Unified Data Management |
| UE | User Equipment |
| UPF | User Plane Function |

Those skilled in the art will recognize improvements and modifications to the embodiments of 25 the present disclosure. All such improvements and modifications are considered within the scope of the concepts disclosed herein.

1. A method of operation of an Access and Mobility Management Function, AMF, for a core network of a cellular communications system for a multicast/broadcast, MB, session join procedure, the method comprising:
receiving a MB session join request from a wireless communication device;
selecting a MB Session Management Function, MB-SMF, instance from a set of MB-SMF instances associated with a particular resource identifier that is associated with and/or identifies a data flow or data stream that is transmitted or will be transmitted to each wireless communication devices in a group of wireless communication devices that participate or will participate in the MB session; and
continuing the MB session join procedure using the selected MB-SMF instance.

2. The method of claim 1 wherein the set of MB-SMF instances comprises two or more MB-SMF instances each associated with a same set of resource identifiers that comprises the particular resource identifier.

3. The method of claim 2 wherein the same set of resource identifiers is a same range of resource identifiers.

4. The method of claim 2 wherein the set of MB-SMF instances consists of two or more MB-SMF instances in a MB-SMF pool that is associated with the same set of resource identifiers.

5. The method of claim 2, wherein selecting the MB-SMF instance from the set of MB-SMF instances comprises:
discovering the set of MB-SMF instances; and
selecting the selected MB-SMF instance from the discovered set of MB-SMF instances.

6. The method of claim 5 wherein discovering the set of MB-SMF instances comprises discovering the set of MB-SMF instances based on a local configuration of an association between the same set of resource identifiers and the set of MB-SMF instances.

7. The method of claim 5 wherein discovering the set of MB-SMF instances comprises:
sending a discovery request to a Network Repository Function, NRF, the discovery request comprising the particular resource identifier; and
receiving a response from the NRF that comprises information that identifies the set of MB-SMFs instances.

8. The method of claim 1 wherein selecting the MB-SMF instance from the set of MB-SMF instances comprises:
sending a discovery request to a Network Repository Function, NRF, the discovery request comprising the particular resource identifier;
receiving a response from the NRF that comprises information that identifies one or more MB-SMFs instances; and
selecting the selected MB-SMF instance from the one or more MB-SMF instances.

9. The method of claim 1, wherein the resource identifier is a TMGI.

10. The method of claim 1, wherein the resource identifier is a service ID, an IP multicast address, a UDP port, or a session ID.

11. The method of claim 1, wherein the particular resource identifier is comprised in the MB session join request received from the wireless communication device (212).

12-27. (canceled)

28. A network node that implements an Access and Mobility Management Function, AMF, for a core network of a cellular communications system, the network node comprising processing circuitry configured to cause the network node to:
receive a multicast/broadcast, MB, session join request from a wireless communication device;
select a MB Session Management Function, MB-SMF, instance from a set of MB-SMF instances associated with a particular resource identifier that is associated with and/or identifies a data flow or data stream that is transmitted or will be transmitted to each wireless communication devices in a group of wireless communication devices that participate or will participate in the MB session; and
continue the MB session join procedure using the selected MB-SMF instance.

29. The network node of claim 28, wherein the set of MB-SMF instances comprises two or more MB-SMF instances each associated with a same set of resource identifiers that comprises the particular resource identifier.

30. The network node of claim 29, wherein the same set of resource identifiers is a same range of resource identifiers.

31. The network node of claim 29, wherein the set of MB-SMF instances consists of two or more MB-SMF instances in a MB-SMF pool that is associated with the same set of resource identifiers.

32. The network node of claim 29, wherein in order to select the MB-SMF instance from the set of MB-SMF instances, the processing circuitry is further configured to cause the network node to:
discover the set of MB-SMF instances; and
select the selected MB-SMF instance from the discovered set of MB-SMF instances.

33. The network node of claim 32, wherein in order to discover the set of MB-SMF instances, the processing circuitry is further configured to cause the network node to discover the set of MB-SMF instances based on a local configuration of an association between the same set of resource identifiers and the set of MB-SMF instances.

34. The network node of claim 32, wherein in order to discover the set of MB-SMF instances, the processing circuitry is further configured to cause the network node to:
send a discovery request to a Network Repository Function, NRF, the discovery request comprising the particular resource identifier; and
receive a response from the NRF that comprises information that identifies the set of MB-SMFs instances.

35. The network node of claim 28, wherein selecting the MB-SMF instance from the set of MB-SMF instances comprises:
sending a discovery request to a Network Repository Function, NRF, the discovery request comprising the particular resource identifier;
receiving a response from the NRF that comprises information that identifies one or more MB-SMFs instances; and
selecting the selected MB-SMF instance from the one or more MB-SMF instances.

36. The network node of claim 28, wherein:
the resource identifier is a TMGI;
the resource identifier is a service ID, an IP multicast address, a UDP port, or a session ID; or
the resource identifier is comprised in the MB session join request received from the wireless communication device.
